(19) United States
(12) Patent Application Publication
(10) Pub. No.: US 2021/0081124 A1
(43) Pub. Date: Mar. 18, 2021

(54) STORAGE DEVICE DEVELOPED BY INHIBITING WRITE SPEED DEGRADATION OF STORAGE DEVICE AND METHOD CONTROLLING THE SAME

(71) Applicants: Kabushiki Kaisha Toshiba, Tokyo (JP); Toshiba Electronic Devices & Storage Corporation, Tokyo (JP)

(72) Inventor: Kazuto Kashiwagi, Yokohama Kanagawa (JP)

(21) Appl. No.: 16/804,493

(22) Filed: Feb. 28, 2020

(30) Foreign Application Priority Data
Sep. 18, 2019 (JP) 2019-169218

(51) Int. Cl. G06F 3/06; G11B 5/012; G11B 5/52

(52) U.S. Cl. CPC G06F 3/0634; G06F 3/0658; G11B 5/52; G06F 3/0679; G11B 5/012; G06F 3/0604

(57) ABSTRACT

According to one embodiment, a storage device includes a storage medium, and a controller which controls reading and writing of data from and to the storage medium. The controller detects write-off-track having a write-off-track amount larger than a threshold value when the data is written, and interrupts writing of the data when the write-off-track is detected. The controller acquires a degradation amount of a write speed or a degree value indicating a degree of the write-off-track, when the write-off-track amount is equal to or smaller than the threshold value. The controller changes the threshold value based on the degradation amount or the degree value.

### CROSS-REFERENCE TO RELATED APPLICATIONS

This application is based upon and claims the benefit of priority from Japanese Patent Application No. 2019-169218, filed Sep. 18, 2019, the entire contents of which are incorporated herein by reference.

### FIELD

Embodiments described herein relate generally to a storage device and a method controlling the same.

### BACKGROUND

There is a magnetic disk device as an example of a storage device. The magnetic disk device writes data for a disk-shaped magnetic disk.

### BRIEF DESCRIPTION OF THE DRAWINGS

FIG. 1 is a block diagram illustrating an example of a configuration of a storage device according to a first embodiment.

FIG. 2 is a flowchart illustrating an example of a process during writing performed by the storage device according to the first embodiment.

FIG. 3 is a block diagram illustrating an example of a configuration of a storage device according to a second embodiment.

FIG. 4 is a flowchart illustrating an example of a process during writing performed by the storage device according to the second embodiment.

FIG. 5 is a block diagram illustrating an example of a configuration of a storage device according to a third embodiment.

FIG. 6 is a flowchart illustrating an example of a process during writing performed by the storage device according to the third embodiment.

FIG. 7 is a block diagram illustrating an example of a configuration of a storage device according to a fourth embodiment.

FIG. 8 is a flowchart illustrating an example of a process during writing performed by the storage device according to the fourth embodiment.

### DETAILED DESCRIPTION

An embodiment will be described hereinafter with reference to the accompanying drawings. In the following description, constituent elements having substantially the same function and configuration will be denoted by the same reference number, and description will be repeated only when necessary. Further, the following embodiment illustrates a device and a method which give concrete forms to technical ideas, and the technical ideas of the embodiment are not intended to limit materials, shapes, structures, arrangements, etc., of components to those descried below. The technical ideas of the embodiment can be modified in various manners in the scope of patent claims.

In general, according to one embodiment, a storage device includes a storage medium, and a controller. The controller controls reading and writing of data from and to the storage medium. The controller detects write-off-track having a write-off-track amount larger than a threshold value when the data is written. The write-off-track amount indicates a degree of influence on peripheral data which is recorded on a periphery of a writing destination of the data. The controller interrupts writing of the data when the write-off-track is detected. The controller acquires at least one of a degradation amount of a write speed or a degree value indicating a degree of the write-off-track, when the write-off-track amount is equal to or smaller than the threshold value. The controller changes the threshold value based on at least one of the degradation amount or the degree value.

Hereinafter, a case where a storage device is a magnetic disk device is described as an example; however, the storage device may be an optical disk device, for example.

### First Embodiment

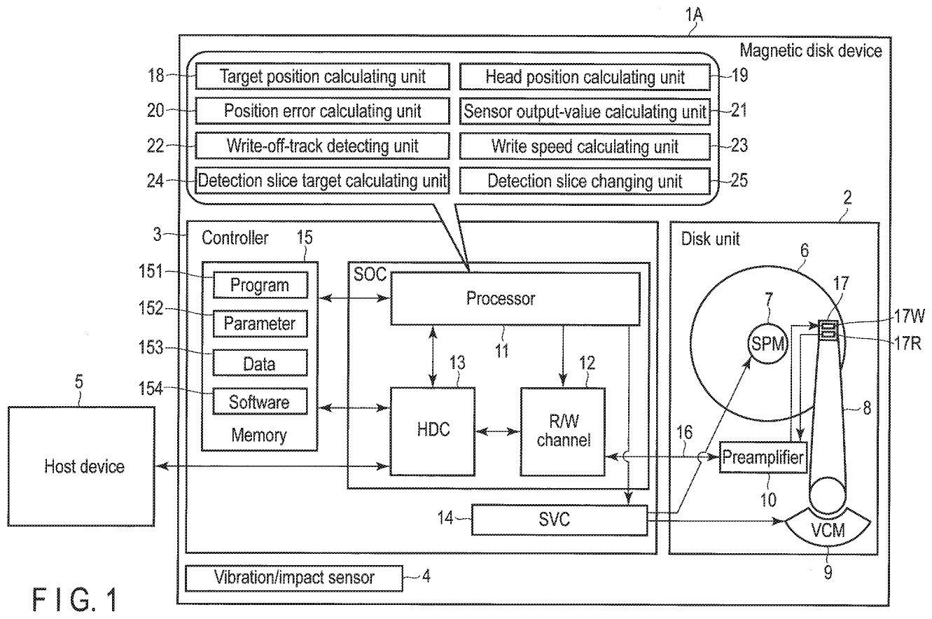

FIG. 1 is a block diagram illustrating an example of a configuration of a magnetic disk device 1A according to a first embodiment.

The magnetic disk device 1A includes a disk unit 2, a controller 3, and a vibration/impact sensor 4.

The magnetic disk device 1A is communicationally connected to a host device 5 such as an information processing device, for example.

The disk unit 2 includes a magnetic disk 6, a spindle motor (hereinafter, referred to as “SPM”) 7, a magnetic head 8, a voice coil motor (hereinafter, referred to as “VCM”) 9, and a preamplifier 10.

The controller 3 includes a processor 11, a read/write (R/W) channel 12, a hard disk controller (hereinafter, referred to as “HDC”) 13, a servo combo (hereinafter, referred to as “SVC”) 14, and a memory 15.

The preamplifier 10 and the R/W channel 12 are connected to each other via a plurality of signal lines 16.

The processor 11, the R/W channel 12, and the HDC 13 may be formed in one chip by a system on chip.

For example, the magnetic disk 6 has a substrate which is formed into a disk shape and is made of a non-magnetic material. On each surface of the substrate, a soft magnetic layer which is provided as an underlayer and is made of a material having a soft magnetic property, a magnetic recording layer on an upper layer portion of the soft magnetic layer, the magnetic recording layer having magnetic anisotropy in a perpendicular direction with respect to a disk surface, and a protective film layer are stacked in that order of description.

The magnetic disk 6 is fixed to the SPM 7. The magnetic disk 6 rotates at a predetermined speed as the SPM 7 rotates. In the first embodiment, a plurality of magnetic disks 6 are installed at the SPM 7. However, the number of magnetic disks 6 which are installed at the SPM 7 may be set to one or more. The SPM 7 is driven with a drive current (or drive voltage) which is supplied from the SVC 14.

The magnetic head 8 includes a slider 17 at a distal portion thereof. The slider 17 has a write (recording) head 17W and a read (reproducing) head 17R.

A plurality of magnetic heads 8 are provided corresponding to the number of magnetic disks 6.

The write head 17W writes a write signal on a track of the magnetic disk 6.

The read head 17R reads a read signal from a track of the magnetic disk 6.

The VCM 9 rotatably supports an actuator having the magnetic head 8 at a distal portion thereof. The VCM 9 rotates the actuator in response to control performed by the controller 3. Consequently, the magnetic head 8 moves to a location on a desired track of the magnetic disk 6 and is positioned at the location. The VCM 9 is driven with a drive current (or drive voltage) which is supplied from the SVC 14.

The preamplifier 10 supplies, the write head 17W, a write signal (write current) in response to data which is supplied from the R/W channel 12. In addition, the preamplifier 10 amplifies a read signal output from the read head 17R and transmits the amplified signal to the R/W channel 12.

The processor 11 is a main controller of the magnetic disk device 1A and executes control of a read/write operation of the disk unit 2 and servo control needing to position the magnetic head 8. As the processor 11, a central processing unit (CPU) or a microprocessor unit (MPU) is used, for example.

The R/W channel 12 is a signal processing circuit that executes processing of a signal in association with read/write. The R/W channel 12 includes a read channel that executes signal processing of read data and a write channel that executes signal processing of write data. The R/W channel 12 converts the read signal into digital data and demodulates the read signal. The R/W channel 12 encodes digital data transmitted from the HDC 13 so as to generate a write signal and transmits the write signal to the preamplifier 10.

The HDC 13 configures an interface between the magnetic disk device A and the host device 5 and executes transmission control of read data and write data. That is, the HDC 13 functions as a host interface controller that receives a signal transmitted from the host device 5 and transmits a signal to the host device 5.

When the HDC 13 transmits read data to the host device 5, the HDC 13 executes an error correcting process of read data read by the magnetic head 8 and demodulated according to the processor 11. In addition, the HDC 13 receives a command (write command, read command, or the like) which is transmitted from the host device 5 and transmits the received command to the processor 11.

The SVC 14 controls driving of the SPM 7 and the VCM 9 in response to control performed by the processor 11. As the SPM 7 and the VCM 9 are driven, the magnetic head 8 is positioned at a target track on the magnetic disk 6.

For example, the memory 15 may include a read only memory (ROM) which is a non-volatile memory and a random access memory (RAM) which is a volatile memory. For example, the memory 15 stores a program 151, a parameter 152, data 153, and software 154 which are necessary for processing performed by the processor 11.

In the first embodiment, for example, the processor 11 functions as a target position calculating unit 18, a head position calculating unit 19, a position error calculating unit 20, a sensor output-value calculating unit 21, a write-off-track detecting unit 22, a write speed calculating unit 23, a detection slice target calculating unit 24, and a detection slice changing unit 25.

Incidentally, at least a part of the target position calculating unit 18, the head position calculating unit 19, the position error calculating unit 20, the sensor output-value calculating unit 21, the write-off-track detecting unit 22, the write speed calculating unit 23, the detection slice target calculating unit 24, and the detection slice changing unit 25 may be realized by an electronic circuit or may be realized by the processor 11 executing the software 154 which is stored in the memory 15. At least a part of the target position calculating unit 18, the head position calculating unit 19, the position error calculating unit 20, the sensor output-value calculating unit 21, the write-off-track detecting unit 22, the write speed calculating unit 23, the detection slice target calculating unit 24, and the detection slice changing unit 25 may be realized by a configurational element other than the processor 11.

The target position calculating unit 18 calculates or acquires a write target position of a track, based on a pitch between a track and another track adjacent to the track. At the track, recording is performed by sector unit demarcated microscopically in a circumferential direction.

The head position calculating unit 19 calculates or acquires a position of the write head 17W, based on a servo read signal which is included in a read signal that is read by the read head 17R.

The position error calculating unit 20 calculates or acquires a position error for each sector of the track, based on the write target position and the position of the write head 17W.

The vibration/impact sensor 4 detects a posture change of a movable mass inside the sensor through a piezoelectric effect, a capacitance change, or other means, converts a detection result into an electric signal, and transmits the electric signal to the sensor output-value calculating unit 21. Incidentally, the vibration/impact sensor 4 may be provided as a part of the disk unit 2 or a part of the controller 3.

The sensor output-value calculating unit 21 receives the electric signal from the vibration/impact sensor 4, executes a filtering process, an integration process, or another process on the electric signal as necessary, and converts the electric signal into a numerical value.

When the write-off-track detecting unit 22 compares a write-off-track amount and a detection slice, and the write-off-track amount is larger than the detection slice, the write-off-track detecting unit interrupts writing. Incidentally, when the write-off-track detecting unit 22 may interrupt writing when the write-off-track amount is equal to or larger than the detection slice, depending on implementation.

In the first embodiment, for example, when data is written to the magnetic disk 6, the write-off-track amount is a value indicating a degree of influence on peripheral data which is written on a periphery of a writing destination of the data. More specifically, the write-off-track amount is a quantified amount of a risk of corruption of peripheral data which is written on the periphery of the writing destination of the data. For example, as the write-off-track amount, a position error amount, a sensor output value, or the like may be used, or another value may be used.

In the first embodiment, the detection slice is a reference amount which is used for determining and detecting write-off-track based on a write-off-track amount. In other words, the detection slice is a threshold value.

A state where the write-off-track amount is larger than the detection slice may be simply described as the write-off-track. Comparison of the write-off-track amount and the detection slice may be comparison of one of quantified amounts of risks of corruption of peripheral data and one detection slice or may be comparison of a plurality of write-off-track amounts and a plurality of detection slices.

When data is written in the magnetic disk device 1A of the first embodiment, the magnetic disk device 1A first moves the write head 17W to a write target sector at which the first data is written. Next, the position error calculating unit 20 calculates or acquires a position error of a target position of the write head 17W, based on a demodulation result of a servo signal. Next, when a write-off-track amount is larger than a detection slice, the write-off-track detecting unit 22 interrupts writing, then, has a rotational waiting until the sector appears under the write head 17W, and again tries the writing. When the write-off-track amount is equal to or smaller than the detection slice, and data to be written still remains, the magnetic disk device 1A updates the data to be written and again performs writing. When the write-off-track amount is equal to or smaller than the detection slice, and no data to be written remains, the magnetic disk device 1A ends the writing.

As described above, when the write-off-track amount during data writing exceeds the detection slice, the magnetic disk device 1A interrupts the writing. In the magnetic disk device 1A according to the first embodiment, the detection slice which is used for such an interrupting operation is dynamically set in an actual operating environment after shipment.

Incidentally, an upper limit and a lower limit of a variable range of the detection slice may be set at the time of design or in a manufacturing step of the magnetic disk device 1A. The magnetic disk device 1A optimizes a balance between write speed degradation due to a rotational waiting of writing and a quality degradation risk of adjacent recording, by the interrupting operation of writing.

In order to perform such optimization, the magnetic disk device 1A of the first embodiment includes the write-off-track detecting unit 22, the detection slice target calculating unit 24, and the detection slice changing unit 25, with the write speed calculating unit 23.

The write speed calculating unit 23 calculates or acquires a degradation amount of the write speed based on a write-off-track frequency at a detection slice at the time of current writing, regarding a sector at which writing is performed at the time of current writing. Here, the write speed means efficiency per time of a writing operation, and the write speed may be described as a write-transmission amount (unit: MiB/s) per unit time or may be described as the number of write requests (unit: IOPS) processed per unit time. Incidentally, instead of the write speed or together with the write speed, a value indicating other write performance may be used.

The detection slice target calculating unit 24 calculates or acquires a detection slice (hereinafter, referred to as a “detection slice target”) to be newly set, based on both the calculated or acquired degradation amount of the write speed and a target value indicating a write speed requested for the magnetic disk device 1A. Specifically, the detection slice target calculating unit 24 calculates or acquires the detection slice target such that the degradation amount of the write speed is within an allowable range.

The detection slice changing unit 25 changes the detection slice by using the calculated or acquired detection slice target.

Consequently, the detection slice to be used for write-off-track detection can be reduced within a range of the write speed which is allowed by a user, and thus it is possible to improve a read/write quality.

The first embodiment is described further in detail.

The write speed calculating unit 23 first counts the number of write-off-track detection occurrences per number of write trails and calculates or acquires a rate of the number of write trials and the number of write-off-track detection occurrences, thereby, calculating or acquiring a write-off-track frequency in real time.

A unit of the number may be the number of passing servo sectors in the write range or may be the number of data sectors which are write targets.

A management range of the write-off-track frequency may be an entire range of a user region which is usable in the magnetic disk device 1A, may be for each magnetic head 8, or may be a radius region on a surface of a storage medium in which the magnetic head 8 performs recording.

For example, the write-off-track frequency is a frequency of occurrence of the write-off-track which is obtained by dividing the number of write-off-track detection occurrences during a predetermined period by the number of write trials.

The detection slice target calculating unit 24 first determines whether or not the write-off-track frequency satisfies a predefined write speed degradation limit dₗᵢₘᵢₜ which is allowed, based on the calculation or acquisition result of the write speed calculating unit 23.

When the write-off-track frequency is P, an actual degradation amount dᵣ of the write speed is calculated or acquired from the following Formula (1) by using an average rotation waiting time sᵣ and an average servo sampling cycle ss.

$${d}_{r} = \frac{( 1 - P ) \cdot {s}_{s} + P \cdot {s}_{r}}{{s}_{s}} \qquad Formula ( 1 )$$

When the actual degradation amount dᵣ is smaller than the allowable limit dₗᵢₘᵢₜ, the detection slice target can be reduced. Then, the detection slice target calculating unit 24 calculates or acquires a new reduced detection slice target Th_{target} with respect to a detection slice Thᵣ at the time of current writing. The new detection slice target Th_{target} is sequentially calculated or acquired and updated by the following Formula (2) using a difference between the allowable limit dₗᵢₘᵢₜ and the actual degradation amount dᵣ of the write speed, the detection slice Thᵣ at the time of writing, and a proportionality coefficient k suitable for proportional control, for example.

Th_{target}=k(dᵣ−dₗᵢₘᵢₜ)+Thᵣ Formula (2)

The detection slice changing unit 25 changes the detection slice Thᵣ which is used for write-off-track detection in subsequent writing, by using the detection slice target Th_{target} calculated or acquired by the detection slice target calculating unit 24.

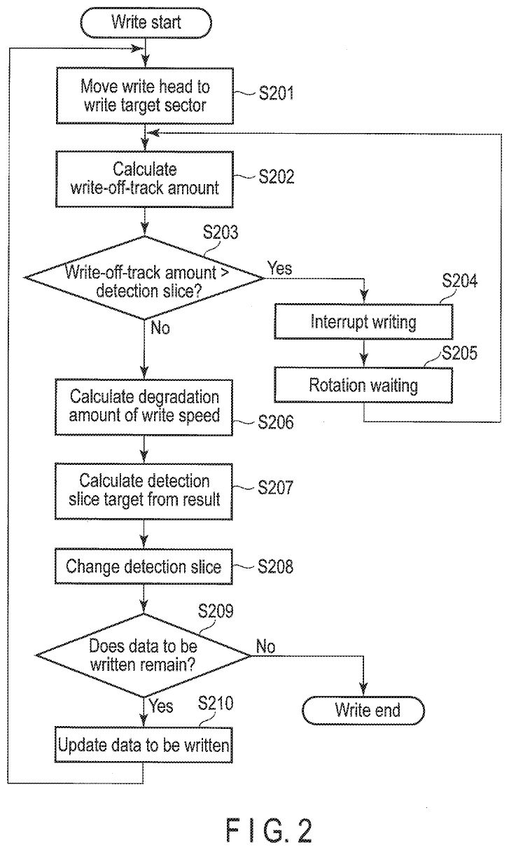

FIG. 2 is a flowchart illustrating an example of a process during writing performed by the magnetic disk device 1A according to the first embodiment.

In Step S201, the magnetic disk device 1A moves the write head 17W to a position of a write target sector.

In Step S202, at least one of the position error calculating unit 20 and the sensor output-value calculating unit 21 calculates or acquires the write-off-track amount.

In Step S203, the write-off-track detecting unit 22 determines whether or not the write-off-track amount is larger than the detection slice.

When the write-off-track amount is larger than the detection slice, the write-off-track detecting unit 22 interrupts writing in Step S204, and the write-off-track detecting unit 22 has a rotation waiting and tries the writing again in Step S205. Subsequently, the process proceeds to Step S202.

When the write-off-track amount is equal to or smaller than the detection slice, the write speed calculating unit 23 calculates or acquires the degradation amount of the write speed based on the write-off-track frequency in Step S206.

In Step S207, the detection slice target calculating unit 24 calculates or acquires the detection slice target such that the calculated or acquired degradation amount of the write speed is within the allowable range.

In Step S208, the detection slice changing unit 25 changes the detection slice based on the detection slice target.

In Step S209, the magnetic disk device 1A determines whether or not data to be written remains.

When no data to be written remains, the process is ended.

When data to be written remains, the magnetic disk device 1A updates data to be written and performs writing again in Step S210.

Effects of the magnetic disk device 1A according to the first embodiment described above are described in comparison to Comparative Examples 1 and 2.

In the magnetic disk device 1A having a high recording density, the write-off-track detecting unit 22 is used. The write-off-track detecting unit 22 interrupts writing, when a write-off-track amount represented by a position error amount calculated or acquired by modulating a servo signal during writing or an output value from the vibration/impact sensor 4 exceeds the detection slice. Consequently, when data is written on the magnetic disk 6, it is possible to inhibit unintentional erasure of data written on an adjacent recording track in advance due to over interference and to prevent a write quality from being degraded.

In Comparative Examples 1 and 2, there is assumed a case where a detection slice which is used by the write-off-track detecting unit 22 is set at the time of design or in a manufacturing step of the magnetic disk device and is not changed thereafter.

In Comparative Example 1, the detection slice is adjusted at the time of design or in the manufacturing step, depending on a read/write quality which is allowed in the design of the magnetic disk device and a maximum disturbance input to be assumed. For example, in Comparative Example 1, regarding an occurrence probability distribution of position errors which occur in a maximum disturbance applying environment that is set in a specification of the magnetic disk device and a customer specification, a frequency of write interruption to be allowed to occur is computed from a degradation limit of the write speed which is allowed under the environment. Also, regarding a position error probability distribution, a detection slice which is the frequency of write interruption to be allowed is calculated or acquired, and the detection slice is set in the magnetic disk device in advance.

In Comparative Example 2, an allowable record position error amount is calculated or acquired from a read/write quality obtained by actual measurement for each magnetic disk device, a position error measured in an environment of the manufacturing step, or an occurrence probability distribution of output values from the vibration/impact sensor 4. Also, in Comparative Example 2, the detection slice is set in the manufacturing step in advance so as to interrupt an off-track having a position error amount equal to or larger than the allowable record position error amount.

The detection slice set in Comparative Examples 1 and 2 is not absolutely optimized to individual environments in which magnetic disk devices are actually installed. For example, as an installation state of a storage server which includes the magnetic disk device changes, a suitable detection slice also changes. In addition, a difference in vibrations occurring with respect to installed magnetic disk devices occurs due to a positional relationship between an insertion slot in the storage server and a vibration source represented by a fan that cools the storage server, and thus detection slices suitable for the magnetic disk devices are different from each other in some cases. Therefore, as described in Comparative Examples 1 and 2, when the detection slice is fixedly set at the time of design or in the manufacturing step, an appropriate balance is not obtained between write speed degradation due to the rotation waiting of writing in association with the write interruption and a quality degradation risk of adjacent recording due to no write pause in some cases.

By contrast, in the first embodiment, it is possible to change the detection slice within a range of satisfying the requested write speed. More specifically, in the magnetic disk device 1A according to the first embodiment, it is possible to dynamically optimize the detection slice depending on an operation state after shipment, within a range in which a balance between write speed degradation due to the rotation waiting of writing in association with the write interruption and quality degradation of adjacent recording due to no write interruption is ensured.

Hence, in the first embodiment, it is possible to detect in real time that the write-off-track amount is larger than the detection slice, to reduce an opportunity of write interruption so as to inhibit the write speed from being degraded regarding the write-off-track detection at which a write sequence is interrupted, and to improve the write quality.

### Second Embodiment

The second embodiment is a modification example of the first embodiment, and a write-off-track degree value indicating a degree of write-off-track is used instead of the degradation amount of the write speed in the first embodiment. Incidentally, the second embodiment is applicable to a combination with the first embodiment.

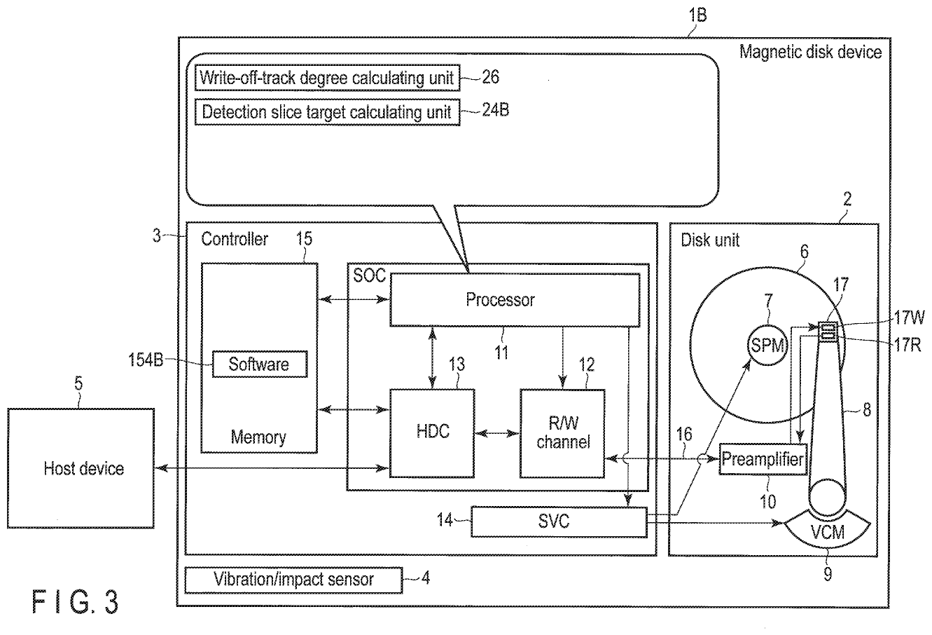

FIG. 3 is a block diagram illustrating an example of a configuration of a magnetic disk device 1B according to the second embodiment. Regarding functions which are realized by a processor 11 in FIG. 3, only some of the functions different from the functions which are realized by the processor 11 in FIG. 1 are described, and thus the same functions are omitted.

The processor 11 of the magnetic disk device 1B functions as a write-off-track degree calculating unit 26 and a detection slice target calculating unit 24B. The write-off-track degree calculating unit 26 and the detection slice target calculating unit 24B are used instead of the write speed calculating unit 23 and the detection slice target calculating unit 24 according to the first embodiment. Incidentally, at least a part of the write-off-track degree calculating unit 26 and the detection slice target calculating unit 24B may be realized by an electronic circuit or may be realized by the processor 11 executing software 154B which is stored in a memory 15. At least a part of the write-off-track degree calculating unit 26 and the detection slice target calculating unit 24B may be realized by a configurational element other than the processor 11.

When the write-off-track amount is equal to or smaller than the detection slice, the write-off-track degree calculating unit 26 calculates or acquires a write-off-track degree value from the write-off-track amount during writing, in real time. For example, the write-off-track degree value may be a standard deviation of write-off-track amounts during the writing in a certain period. The write-off-track degree value is calculated or acquired from the following Formula (3), when the write-off-track amount during writing is observed for each servo frame through which to pass.

$${σ}_{N} = \sqrt{\frac{N \cdot {σ}_{N - 1} + {x}_{N - 1}^{2}}{N + 1}} \qquad Formula ( 3 )$$

For example, the detection slice target calculating unit 24B calculates or acquires a detection slice target by using a current detection slice Thᵣ and a standard deviation 6N of write-off-track amounts in a certain period, the standard deviation being calculated or acquired as the write-off-track degree value by the write-off-track degree calculating unit 26. For example, the detection slice target calculating unit 24B sequentially calculates or acquires the detection slice target Th_{target} from the following Formula (4).

Th_{target}=g·k·σ_{N}+(1−g)Thᵣ Formula (4)

Here, g represents an update gain, and a rapid change of the detection slice is prevented.

Incidentally, the detection slice target calculating unit 24B may calculate or acquire the detection slice target such that the calculated or acquired write-off-track degree value is within an allowable range.

The detection slice changing unit 25 changes the detection slice such that the detection slice target Th_{target} calculated or acquired by the detection slice target calculating unit 24B is used for write-off-track detection in subsequent writing.

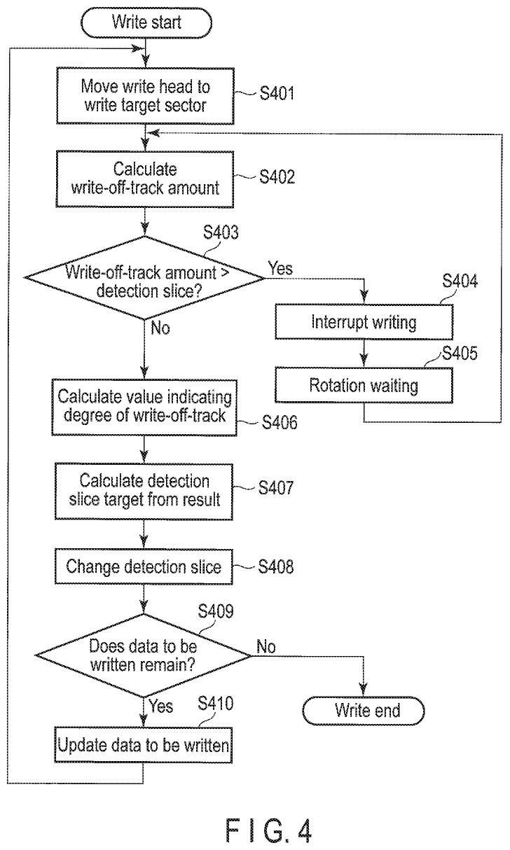

FIG. 4 is a flowchart illustrating an example of a process during writing performed by the magnetic disk device 1B according to the second embodiment.

Steps S401 to S405 are the same as Steps S201 to S205 described above.

When the write-off-track amount is equal to or smaller than the detection slice in Step S403, the write-off-track degree calculating unit 26 calculates or acquires the write-off-track degree value in Step S406.

In Step S407, the detection slice target calculating unit 24B calculates or acquires the detection slice target based on the calculated or acquired write-off-track degree value and the detection slice.

The subsequent Steps S408 to S410 are the same as Steps S208 to S210 described above.

In the second embodiment described above, it is possible to change the detection slice within a range of satisfying the requested write speed, depending on a degree of the write-off-track. More specifically, in the second embodiment, it is possible to dynamically optimize the detection slice depending on a degree of the write-off-track, and it is possible to reduce an opportunity of write interruption so as to inhibit the write speed from being degraded and to improve the write quality, regarding the write-off-track detection.

### Third Embodiment

The third embodiment is a modification example of the first embodiment and the second embodiment, and a change of the detection slice is performed by using a calculation or acquisition value of the read/write quality. The third embodiment is applicable to a combination with at least one of the first embodiment and the second embodiment.

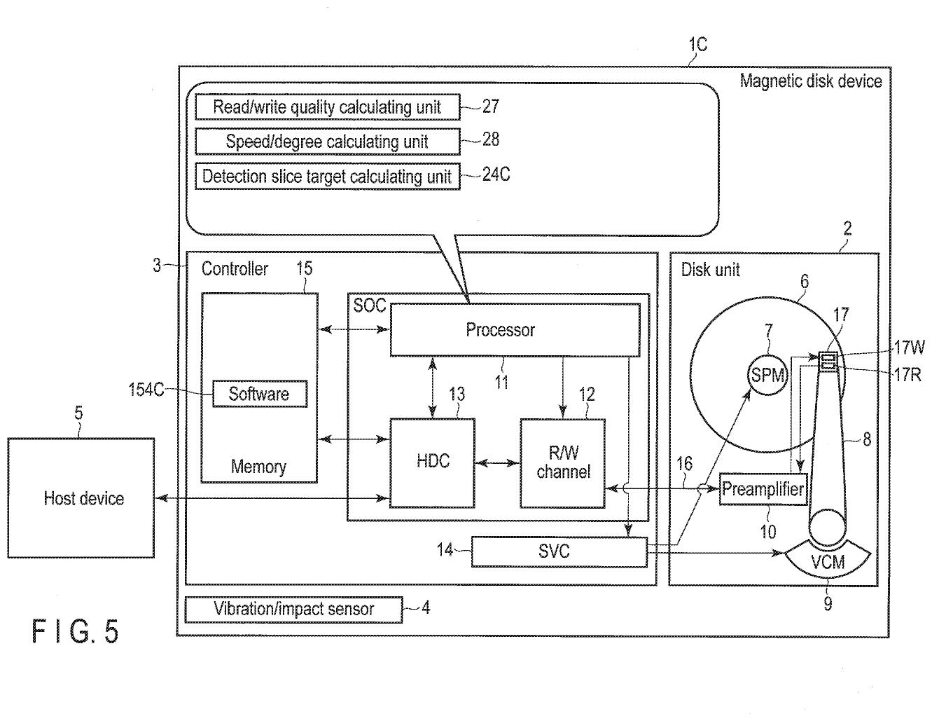

FIG. 5 is a block diagram illustrating an example of a configuration of a magnetic disk device 1C according to the third embodiment. Regarding functions which are realized by a processor 11 in FIG. 5, only some of the functions different from the functions which are realized by the processor 11 in FIG. 1 are described, and thus the same functions are omitted.

The processor 11 of the magnetic disk device 1C functions as a read/write quality calculating unit 27.

Further, the processor 11 functions as a speed/degree calculating unit 28 and a detection slice target calculating unit 24C. The speed/degree calculating unit 28 and the detection slice target calculating unit 24C are used instead of the write speed calculating unit 23 and the detection slice target calculating unit 24 according to the first embodiment.

Incidentally, at least a part of the read/write quality calculating unit 27, the speed/degree calculating unit 28, and the detection slice target calculating unit 24C may be realized by an electronic circuit or may be realized by the processor 11 executing software 154C which is stored in a memory 15. At least a part of the read/write quality calculating unit 27, the speed/degree calculating unit 28, and the detection slice target calculating unit 24C may be realized by a configurational element other than the processor 11.

When the write-off-track is detected and write interruption occurs, the read/write quality calculating unit 27 calculates or acquires a read/write quality value indicating a read/write quality of a part or an entirety of a peripheral sector having a possibility that an occurrence position (for example, sector) of the write interruption causes over interference, for example. As an index indicating the read/write quality, a bit error rate or a signal-to-noise ratio (SNR), or the like is used.

When the write-off-track amount is equal to or smaller than the detection slice, the speed/degree calculating unit 28 calculates or acquires the degradation amount of the write speed described in the first embodiment and calculates or acquires the write-off-track degree value described in the second embodiment.

The detection slice target calculating unit 24C calculates or acquires the detection slice target based on the degradation amount of the write speed and the write-off-track degree value. For example, the detection slice target calculating unit 24C may select any one (larger one or smaller one) of a first detection slice target calculated or acquired based on the degradation amount of the write speed and a second detection slice target calculated or acquired based on the write-off-track degree value. For example, the detection slice target calculating unit 24C may obtain, as a detection slice target, a calculation or acquisition value (for example, average value) based on the first detection slice target and the second detection slice target.

Further, in the third embodiment, the detection slice target calculating unit 24C puts the read/write quality into calculation or acquisition of the detection slice target. The detection slice target calculating unit 24C compares a quality criterion indicating a read/write quality to be ensured and the read/write quality value obtained by the calculation or acquisition and obtains the detection slice target. For example, the quality criterion may be a predetermined value.

Specifically, when the read/write quality value has a margin smaller than the quality criterion (for example, case where the margin is equal to or smaller than a predetermined value), the detection slice target calculating unit 24C reduces the detection slice. Conversely, when the read/write quality value has a margin larger than the quality criterion (for example, case where the margin is larger than a predetermined value), the detection slice target calculating unit 24C expands the detection slice. In other words, when the write-off-track amount is larger than the detection slice, and the read/write quality value of a sector in which the write interruption occurs and an adjacent sector thereof is larger than a predetermined quality criterion (for example, case where the read/write quality value is larger than the quality criterion), the detection slice target calculating unit 24C stops narrowing-down of the detection slice. Conversely, when the read/write quality value is smaller than the predetermined quality criterion (for example, case where the read/write quality value is equal to or smaller than the quality criterion), the detection slice target calculating unit 24C stops loosening-up of the detection slice.

The detection slice changing unit 25 changes a detection slice which is subsequently used, by using the detection slice target calculated or acquired by the detection slice target calculating unit 24C.

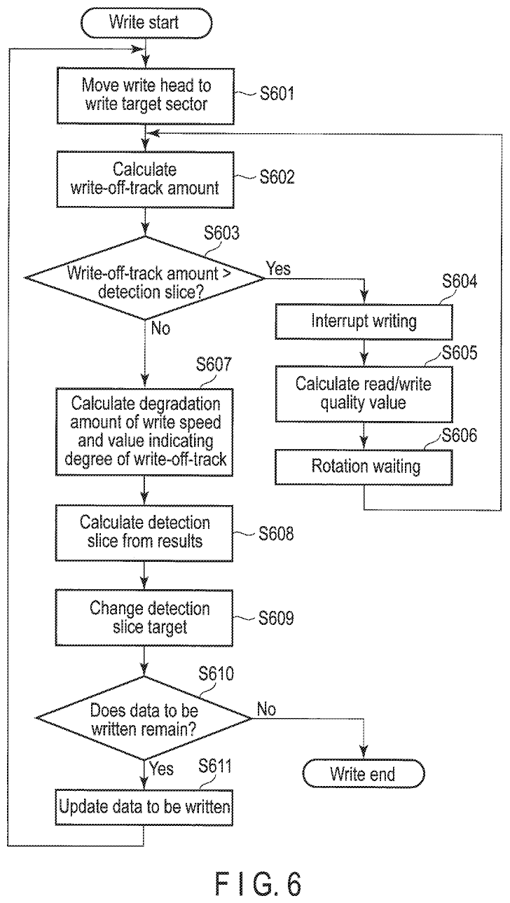

FIG. 6 is a flowchart illustrating an example of a process during writing performed by the magnetic disk device 1C according to the third embodiment.

Steps S601 to S604 are the same as Steps S201 to S204 described above.

In Step S605, the read/write quality calculating unit 27 calculates or acquires the read/write quality value, when the write-off-track is detected and the write interruption occurs. Subsequently, in Step S606, the write-off-track detecting unit 22 has rotation waiting, the writing is again tried, and the process proceeds to Step S602.

When the write-off-track amount is equal to or smaller than the detection slice in Step S603, the speed/degree calculating unit 28 calculates or acquires the degradation amount of the write speed and the write-off-track degree value in Step S607.

In Step S608, the detection slice target calculating unit 24C calculates or acquires the detection slice target based on the degradation amount of the write speed, the calculated or acquired write-off-track degree value, the read/write quality value, and the quality criterion.

The subsequent Steps S609 to S611 are the same as Steps S208 to S210 described above.

In the third embodiment described above, it is possible to change the detection slice within a range of satisfying the requested write speed, depending on a read/write quality on a periphery of a position at which the write interruption occurs. More specifically, in the third embodiment, it is possible to dynamically optimize the detection slice depending on the read/write quality on the periphery of the position at which the write interruption occurs, and it is possible to reduce an opportunity of write interruption so as to inhibit the write speed from being degraded and to improve the write quality, regarding the write-off-track detection.

### Fourth Embodiment

The fourth embodiment differs from the first to third embodiments in that a variable range of the detection slice, that is, an upper limit and a lower limit of the detection slice, is set. In the fourth embodiment, a case where the variable range of the detection slice is set to the first embodiment is described as an example, and the case is the same as a case where the variable range of the detection slice is set to the second or third embodiment.

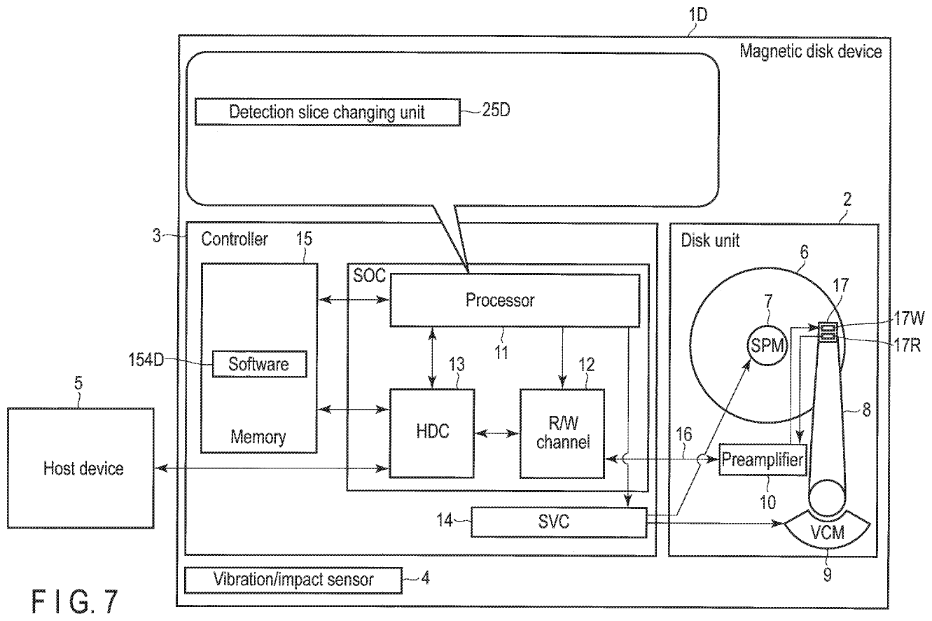

FIG. 7 is a block diagram illustrating an example of a configuration of a magnetic disk device 1D according to the fourth embodiment. Regarding a function which is realized by a processor 11 in FIG. 7, only a part of the function different from the functions which are realized by the processor 11 in FIG. 1 is described, and thus the same functions are omitted.

The processor 11 of the magnetic disk device 1D functions as a detection slice changing unit 25D. The detection slice changing unit 25D is used instead of the detection slice changing unit 25 according to the first embodiment. Incidentally, at least a part of the detection slice changing unit 25D may be realized by an electronic circuit or may be realized by the processor 11 executing software 154D which is stored in a memory 15. At least a part of the detection slice changing unit 25D may be realized by a configurational element other than the processor 11.

When the detection slice target is calculated or acquired, the detection slice changing unit 25D determines whether or not the detection slice target is within a variable range.

When the detection slice target is within the variable range, the detection slice changing unit 25D changes the detection slice, by using the detection slice target.

When the detection slice target is out of the variable range, the detection slice changing unit 25D changes the detection slice within the variable range of the detection slice.

In the fourth embodiment, the variable range of the detection slice may be set at the time of design or in a manufacturing step of the magnetic disk device 1D.

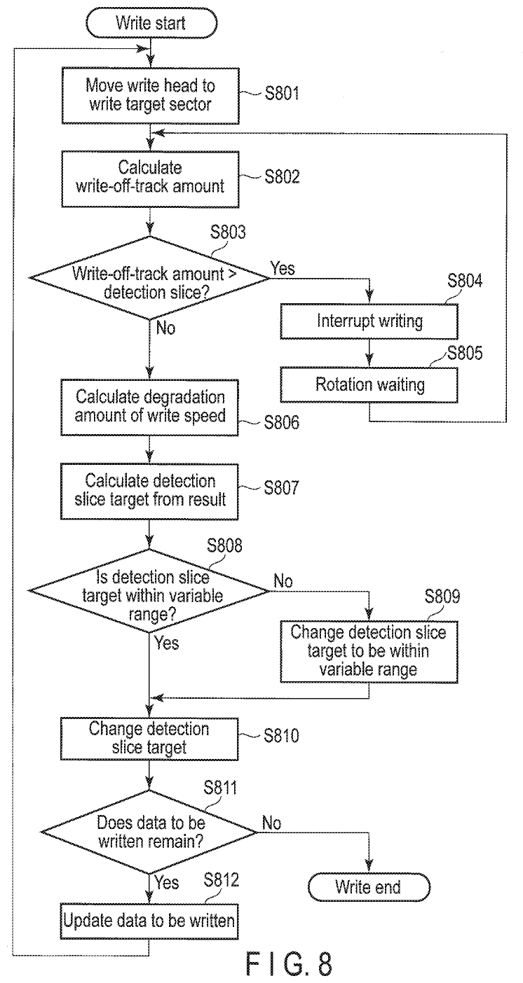

FIG. 8 is a flowchart illustrating an example of a process during writing performed by the magnetic disk device 1D according to the fourth embodiment.

Steps S801 to S807 are the same as Steps S201 to S207 described above.

In Step S808, when the detection slice target is calculated or acquired, the detection slice changing unit 25D determines whether or not the detection slice target is within the variable range.

When the detection slice target is out of the variable range, the change of the detection slice target is performed within the variable range in Step S809. Subsequently, the process proceeds to Step S810.

When the detection slice target is within the variable range, the detection slice changing unit 25D changes the detection slice by using the detection slice target in Step S810.

Steps S811 and S812 are the same as Steps S209 and S210 described above.

In the fourth embodiment described above, it is possible to dynamically optimize the detection slice within a predetermined variable range, and it is possible to reduce an opportunity of write interrupt so as to inhibit the write speed from being degraded and to improve the write quality, regarding the write-off-track detection.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising
a storage medium, and
a controller which controls reading and writing of data from and to the storage medium,
wherein the controller:
detects write-off-track having a write-off-track amount larger than a threshold value when the data is written, the write-off-track amount indicating a degree of influence on peripheral data which is recorded on a periphery of a writing destination of the data, and interrupts writing of the data when the write-off-track is detected;
acquires at least one of a degradation amount of a write speed or a degree value indicating a degree of the write-off-track, when the write-off-track amount is equal to or smaller than the threshold value; and
changes the threshold value based on at least one of the degradation amount or the degree value.

2. The storage device of claim 1,
wherein the threshold value changed by the controller is acquired based on a difference between a write speed allowable limit and the degradation amount, the threshold value at a time of writing, and a proportionality coefficient.

3. The storage device of claim 1,
wherein the write-off-track amount is a position error amount which is acquired based on a write target position and a position of a write head, or a sensor output value from a vibration/impact sensor.

4. The storage device of claim 1,
wherein the write speed is a write-transmission amount per unit time, or the number of write requests processed per unit time.

5. The storage device of claim 1,
wherein the controller
acquires the degradation amount based on a frequency of occurrence of the write-off-track, when the write-off-track amount is equal to or smaller than the threshold value, and
changes the threshold value such that the degradation amount is within an allowable range.

6. The storage device of claim 5,
wherein the degradation amount is acquired based on the frequency of occurrence of the write-off-track, an average rotation waiting time, and an average servo sampling cycle.

7. The storage device of claim 1,
wherein the controller
acquires a standard deviation of write-off-track amounts during a certain period, as the degree value, when the write-off-track amount is equal to or smaller than the threshold value,
acquires a new threshold value based on the degree value and the threshold value, and
changes the threshold value based on the new threshold value.

8. The storage device of claim 7,
wherein, at a time of observation of a write-off-track amount when passing through an N-th servo frame is performed, (N is an integer equal or larger than 2), the standard deviation is acquired using a standard deviation when passing through an N−1-th servo frame is performed.

9. The storage device of to claim 7,
wherein the new threshold value is acquired based on the standard deviation and the threshold value.

10. The storage device of claim 1,
wherein the controller
acquires a quality value indicating a read/write quality of at least a part of the peripheral data, when the write-off-track is detected, and
changes the threshold value based on at least one of the degradation amount or the degree value such that the quality value satisfies a quality criterion of the read/write quality.

11. The storage device of claim 10,
wherein the quality value is a bit error rate or a signal-to-noise ratio (SNR).

12. The storage device of claim 10,
wherein the threshold value changed by the controller is obtained by comparing a quality criterion indicating a read/write quality to be ensured and the quality value.

13. The storage device of claim 12,
wherein the controller stops narrowing-down of the threshold value when the quality value is larger than the quality criterion, and the controller stops loosening-up of the threshold value when the quality value is equal to or smaller than the quality criterion.

14. The storage device of claim 1,
wherein the controller changes the threshold value within a preset variable range.

15. A method for controlling a storage device including a storage medium and a controller which controls reading and writing of data from and to the storage medium, the method comprising
detecting write-off-track having a write-off-track amount larger than a threshold value when the data is written, the write-off-track amount indicating a degree of influence on peripheral data which is recorded on a periphery of a writing destination of the data, and interrupting writing of the data when the write-off-track is detected, by the controller,
acquiring at least one of a degradation amount of a write speed or a degree value indicating a degree of the write-off-track by the controller, when the write-off-track amount is equal to or smaller than the threshold value, and
changing the threshold value based on at least one of the degradation amount or the degree value by the controller.
